(19) United States
(12) Patent Application Publication
(10) Pub. No.: US 2006/0268452 A1
(43) Pub. Date: Nov. 30, 2006

(54) APPARATUS AND METHOD FOR DISK-STACK ASSEMBLY AND TRANSFER WITH TA-C COATING TO REDUCE METALLIC PARTICULATES

(75) Inventors: Poh Whye Chan, Singapore (SG); Kien Wee Lai, Singapore (SG); Jui-Kiat Goh, Singapore (SG); Alex Moraru, Aptos, CA (US)

Correspondence Address: LAWRENCE Y.D. HO & ASSOCIATES PTE LTD, 30 BIDEFORD ROAD, #07-01, THONGSIA BUILDING, SINGAPORE, 229922, SG

(73) Assignee: LaserResearch (S) Pte Ltd, Singapore (SG)

(21) Appl. No.: 11/420,471

(22) Filed: May 25, 2006

Related U.S. Application Data
(60) Provisional application No. 60/684,986, filed on May 27, 2005.

(51) Int. Cl. G11B 17/08

(52) U.S. Cl. 360/98.01

(57) ABSTRACT

The present invention provides a system for assembling a disk-stack with multiple disks and spacers and transferring the assembled disk-stack, a media servowriter that comprises a fixed hub for receiving the assembled disk-stack, and a method that comprises assembling a disk-stack with multiple disks and spacers off-line and transferring the assembled disk-stack to the fixed hub of the media servowriter.

### RELATED APPLICATION

This application claims the benefit under 35 U.S.C. 119(e) of U.S. Provisional Application Ser. No. 60/684,986, filed May 27, 2005, which is herein incorporated by reference.

### FIELD OF THE INVENTION

The present invention relates to multi-disk media servowriters and, more particularly, to a disk-stack assembly and transfer apparatus and method that allows multiple disks and spacers by a stacker/de-stacker module to be stacked before the disk-stack is transferred to a fixed hub or to be de-stacked after the disk-stack is removed from the fixed hub, and further to a method of minimizing metallic contamination incurred during the disk-stack assembly and transfer process.

### BACKGROUND OF THE INVENTION

A typical media servowriter comprises a hub and an air-bearing spindle motor with a rotating shaft, where the hub is attached to the air bearing so that the hub can be rotated by the spindle motor. Usually, the hub has the capacity of receiving a disk-stack with multiple disks and spacers. During servo-track writing, the rotary motion of the spindle air bearing spins the hub and hence the disk-stack it carries. Each read-write head is attached to a head suspension device that is connected to an actuator arm. The actuator arms carrying the read-write heads are inserted in-between the disks while reading or writing on the disk surfaces. Thus, a media servowriter writes on multiple disks simultaneously.

Currently, a disk-stack with multiple disks and spacers for a media servowriter is assembled in two ways. First, a fixed hub is machined and centered on the spindle air bearing so that the disk-stack is assembled piece-by-piece within the fixed hub on the servowriter. The advantage of this approach is that the disk-stack is perfectly centered on the rotating mass, therefore not creating an off-axis imbalance. However, the local assembly of the disk-stack on the Servowriter is time consuming and reduces the utilization of the Servowriter. Second, the media servowriter has a removable hub so that the disk-stack can be assembled on the removable hub outside of the media servowriter, then the removable hub with the disk-stack can be transferred to/from the media servowriter. The advantage of assembly of the disk-stack off-line increases the utilization of the media servowriter. In addition, this method can use one stacking/de-stacking mechanism for multiple media Servowriters. However, the disadvantage is that an error may occur in centering the removable hub on the Servowriter with the addition of centering error of an individual disks on the hub when performed offline. This creates a bigger miss registration of the tracks as well as a larger imbalance—therefore more vibration—during the servowriting process.

Furthermore, stacking and de-stacking operation before and after media servo writing operation where servo data is written to the disks generates metallic particulates on disks. However, the requirement for particulate-free servo-written disks is crucial for reliable disk drive performance.

### SUMMARY OF THE INVENTION

One embodiment of the present invention provides a system for assembling a disk-stack with multiple disks and spacers and transferring the assembled disk-stack. The system comprises a stacker/de-stacker module for assembling the disk-stack with multiple disks and spacers; wherein the stacker/de-stacker module comprises a module base and a shaft integrally attached to the module base, and wherein the shaft is so configured that it has a central thread, and a plurality of guide holes, thereby the multiple disks and spacers are assembled on the shaft to form the disk-stack; a disk-stack interface tool for maintaining the assembled disk-stack during the transfer; wherein the disk-stack interface tool comprises a tool base and a plurality of harden rods integrally attached to the tool base, where the tool base is so configured that it has a plurality of stopper holes; and a transferring means for transferring the assembled disk-stack to a fixed hub of a media servowriter.

Another embodiment of the present invention provides a media servowriter that comprises a fixed hub having a hub base and a hub shaft integrally coupled to the hub base, wherein the hub shaft receives a disk-stack with multiple disks and spacers; a spindle air bearing; wherein the fixed hub is coupled to the spindle air bearing so that the spindle air bearing will rotate the fixed hub in servo-writing process; and a locking means for locking the assembled disk-stack onto the fixed hub.

Another embodiment of the present invention provides a method that comprises assembling a disk-stack with multiple disks and spacers; wherein the disks and spacers are sequentially and alternately disposed against each other on an assembling means off-line; transferring the assembled disk-stack from the assembling means to a fixed hub of a media servowriter by a transferring means; and locking the assembled disk-stack with a locking means.

The above and other objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 shows a plan view of a partial stacker/de-stacker module in accordance with one embodiment of the present invention.

FIG. 2 shows a plan view of a disk-stack interface tool in accordance with one embodiment of the present invention.

FIG. 3 shows an exploded view of assembling multiple disks and spacers on the stacker-de-stacker module in accordance with one embodiment of the present invention.

FIG. 4 shows a plan view of the bottom disk spacer in accordance with one embodiment of the present invention.

FIG. 5 shows a plan view of a gripper employed for transfer the assembled disk-stack from the stacker/de-stacker module to the fixed hub in accordance with one embodiment of the present invention.

FIG. 6 shows a side view of the gripper with its jaws closed on a disk-stack in accordance with one embodiment of the present invention.

FIG. 7 shows a plan view of the gripped disk-stack that is ready to be transferred to the fixed hub of a media servowriter in accordance with one embodiment of the present invention.

FIG. 8 shows a plan view of the disk-stack that has been transferred to the fixed hub in accordance with one embodiment of the present invention.

FIG. 9 shows a plan view of the disk-stack that has been secured to the fixed hub of a media servowriter in accordance with one embodiment of the present invention.

FIG. 10 is a schematic diagram showing the diameter relationships among the fixed hub, disk, and disk-stack interface tool in accordance with one embodiment of the present invention.

FIG. 11 is an exemplary graphic showing the existence of Fe and increase of Cr on a disk by SEM-EDX analysis after the disk went through the stacking/de-stacking process without coating.

FIG. 12 is an exemplary graphic showing the absence of Fe and decrease of Cr on a disk by SEM-EDX analysis after the disk went through the stacking/de-stacking process with Ta—C coating.

FIG. 13 shows a top view of one configuration of the shaft of the fixed hub in accordance with one embodiment of the present invention.

### DETAILED DESCRIPTION OF THE INVENTION

The present invention may be understood more readily by reference to the following detailed description of certain embodiments of the invention. However, it will be understood by those skilled in the relevant art that the present invention may be practiced without these specific details. In other instances, well-known methods, procedures, and components have not been described in detail so as not to obscure the present invention.

Throughout this application, where publications are referenced, the disclosures of these publications are hereby incorporated by reference, in their entireties, into this application in order to more fully describe the state of art to which this invention pertains.

The present invention provides a media servowriter that comprises a fixed hub, wherein the fixed hub is capable of receiving a disk-stack assembled off-line in a stacker/de-de-stacker module. Thus, the media servowriter of the present invention has the combined advantages of reduced miss registration offered by a fixed hub and increased utilization of the media servowriter resulting from the assembly of a disk-stack off-line.

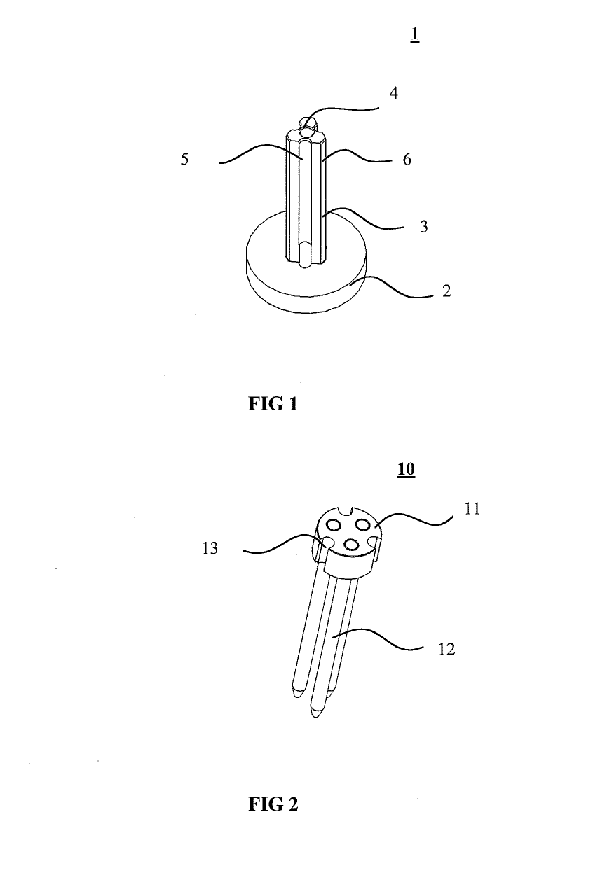

Now referring to FIGS. 1-4, there is provided a detailed description of the stacker/de-stacker module that can be used to assemble a disk-stack off-line in accordance with one embodiment of the present invention.

Referring to FIG. 1, there is provided a plan view of a partial stacker/de-stacker module in accordance with one embodiment of the present invention. The partial stacker/de-stacker module 1 comprises a base 2 and a shaft 3 integrally attached to the module base 2, where the shaft 3 is so configured that it has central thread 4, and a plurality of guide holes 5. The shaft 3 has a shaft diameter 6. While the shaft 3 shown in FIG. 1 has three guide holes, it is to be appreciated that other configurations can also be used.

Referring to FIG. 2, there is provided a plan view of a disk-stack interface tool in accordance with one embodiment of the present invention. The disk-stack interface tool 10 comprises a base 11 and a plurality of harden rods 12 integrally attached to the tool base 11, where the tool base 11 is so configured that it has a plurality of stopper holes 13. While the tool base 11 shown in FIG. 2 has three stopper holes, it is to be appreciated that other configurations can also be used. As shown in FIG. 2, the harden rod 12 has a chamfer or round end to assist the tool during insertion. The shaft 3 of the stacker/de-stacker module has a configuration that is complementary to the one of the harden rods 12 of the disk-stack interface tool. Their use will be described more thereinafter.

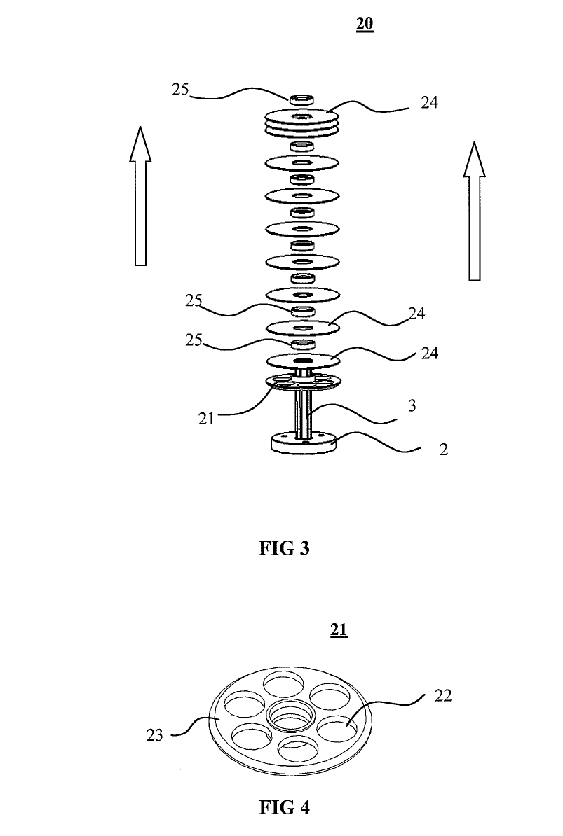

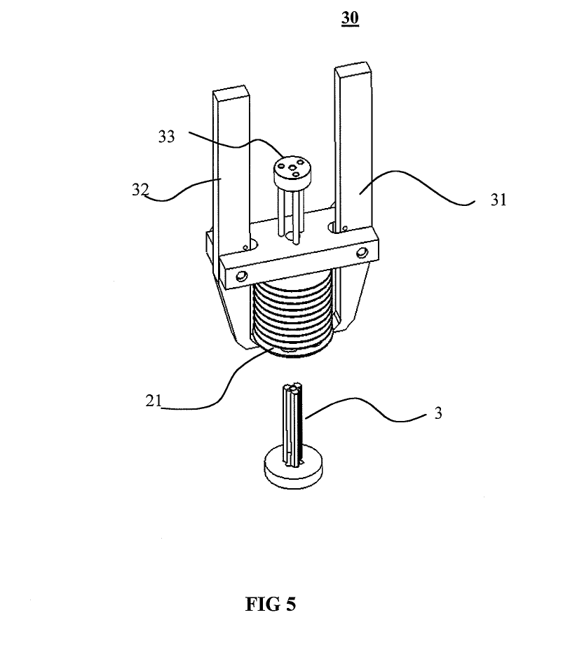

Referring to FIG. 3, there is provided an exploded view of assembling multiple disks and spacers on the stacker-de-stacker module into a disk-stack in accordance with one embodiment of the present invention. The assembly of a disk-stack 20 employs the stacker/de-stacker module 1 with the multiple disks 24 and spacers 25 that are sequentially disposed onto the module shaft 3 alternately with a progress direction shown by the arrows. The disposition of the multiple disks 24 and spacers 25 are being performed by the mechanisms (not shown) located inside the stacker/de-stacker module 1. The disk-stack 20 comprises a bottom disk spacer 21. As shown in FIG. 4, the bottom disk spacer 21 is designed with chamfered feature 23 and relief holes 22 to make the spacer lighter and to reduce the inertia of the disk-stack during spinning.

Now referring to FIGS. 5-9, there is provided a detailed description of the transfer of an assembled disk-stack from the stacker-de-stacker module to the fixed hub of a media servowriter in accordance with one embodiment of the present invention.

Referring to FIG. 5, there is provided a plan view of a gripper employed for transfer the assembled disk-stack from the stacker/de-stacker module to the fixed hub in accordance with one embodiment of the present invention. The gripper 30 comprises a right jaw 31, a left jaw 32, where the two jaws are coupled pivotally to each end of a beam. The beam at central location has a holder 33 that allows the disk-stack interface tool 10 to move freely into the module shaft 3. After the assembly of the disk-stack 20 as shown in FIG. 3 is completed, the gripper 30 is positioned above the disk-stack 20 with the right jaw 31 and left jaw 32 opened. It is to be appreciated that the gripper may have more than two jaws. Then, the disk-stack interface tool 10 mounted to the gripper 30 via the holder 33 will insert its harden rods 12 into the module shaft 3 of the stacker/de-stacker module 1. As noted above, the harden rod 12 is designed with the chamfer or round end to facilitate the insertion. In addition, the harden rod 12 is designed longer than the length from the top spacer to the bottom disk spacer 21, allowing easy insertion of the rods of the disk-stack interface tool 10 into the guide holes 5 of the module shaft 3. The module shaft 3 may comprise multiple steps to allow easy insertion with the harden rods 12. The guided holes 5 may be coated to allow easy sliding for the harden rods 12 so as to prevent metal jamming and fusing caused by the friction. In certain embodiments, the shaft edges are rounded and chamfered to assist the process of insertion. In addition, the module shaft 3 is designed with sliding fit tolerance to allow the harden rods 12 and shaft 3 to slide freely.

During gripping, the holder 33 attached to the gripper 30 may be positioned in the upward orientation to ensure the insertion. Whenever the rod 12 reaches the bottom, a sensor (not shown) will be turned on to indicate that the gripper jaws 31, 32 are ready to be closed. The bottom disk spacer 21 located at the bottom of the assembly secures the gripping. As noted above, the bottom disk spacer 21 as shown in FIG. 4 has a chamfered feature at its peripheral edge to ensure that the jaws grip tightly to the disk-stack. When the jaws 31, 32 are closed as shown in FIG. 5, the disk-stack is ready to be lifted by the gripper 30 and transferred to the fixed hub of a media servowriter. The gripping motion on the jaws 31, 32 and holder 33 can be powered by pneumatic or dc motor in the design to achieve the required task.

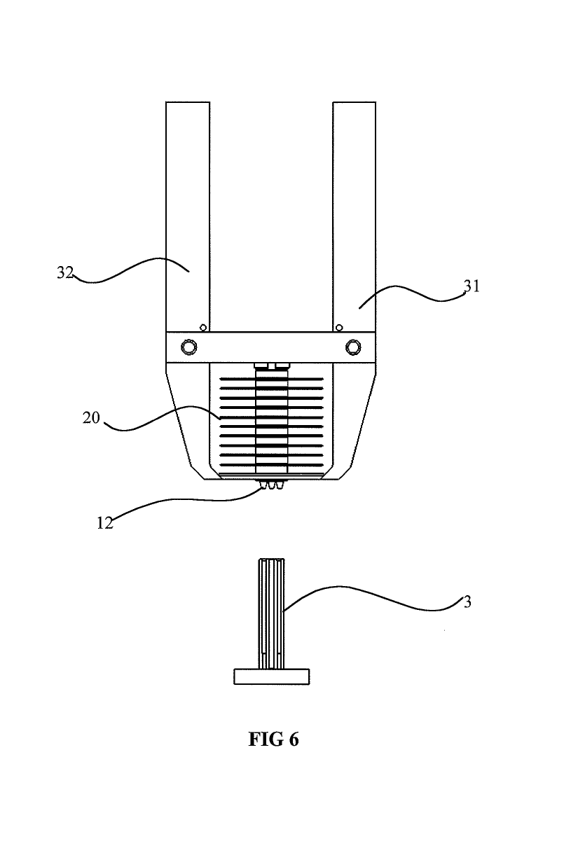

Referring to FIG. 6, there is provided a side view of the gripper with its jaws closed on a disk-stack in accordance with one embodiment of the present invention. The bottom tips of the jaws 31, 32 are tightly gripped to the chamfer edge of the bottom disk spacer 21.

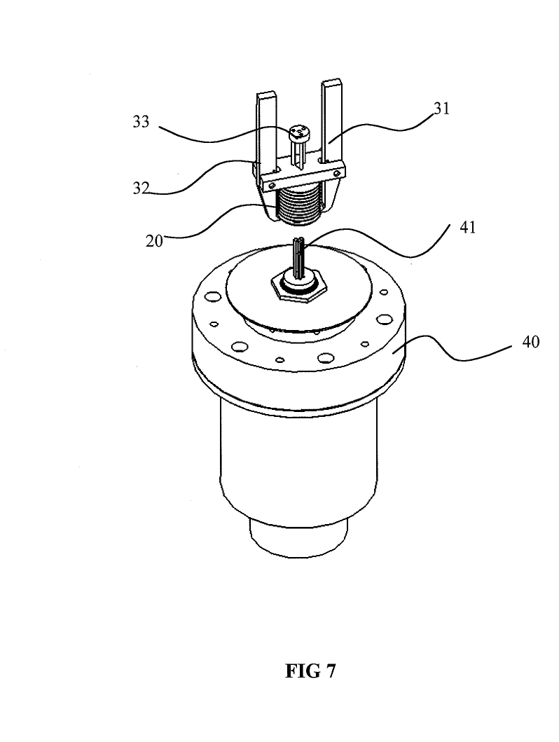

Referring to FIG. 7, there is provided a plan view of the gripped disk-stack that is ready to be transferred to the fixed hub of a media servowriter in accordance with one embodiment of the present invention. The fixed hub 41 is integrally attached to the spindle air bearing 40 that will rotate the fixed hub in servo-writing process. As shown in FIG. 9, the fixed hub 41 and the spindle air bearing 40 are spaced by a fixed clock disk 42 and lock nut 43. The fixed clock disk 42 is preferably bigger than the disks of the disk-stack 20. In addition, the fixed clock disk 42 is positioned lower than the disk-stack 20. The fixed clock disk 42 can be aligned easily to the hub ensuring rigidity and concentricity by the lock nut 43. The alignment of the fixed clock disk 42 can be easily centered through the use of jig and fixture and minimized vibration during spinning at a higher speed. The assembly of the fixed hub and the spindle is well known to those skilled in the art so there is no more detail description provided herein in order not to obscure the present invention. It is to be appreciated that the shaft of the fixed hub 41 has an identical or substantially similar configuration of the shaft 3 of the stacker/de-stacker module 1.

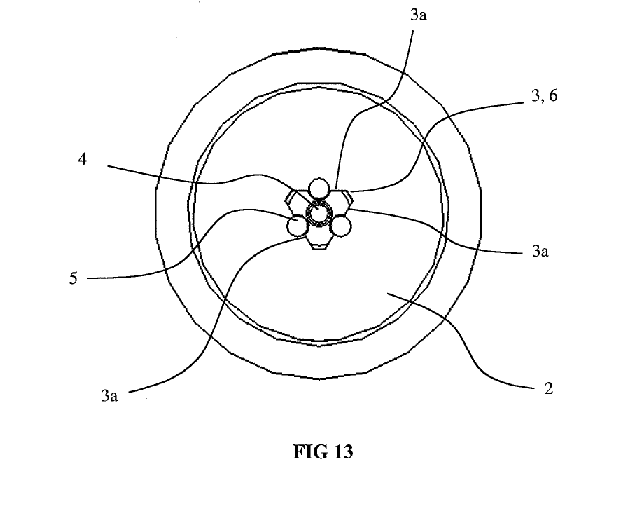

Now referring to FIG. 13, there is provided a top view of one configuration of the shaft of the fixed hub in accordance with one embodiment of the present invention. The shaft has a triangle shape with three faces 3a. The shaft of the fixed hub 41 on the spindle has a design similar to the shaft 3 of the stacker/de-stacker module 1 when performing the disk-stack transfer operation. Before disk-stack is transferred to the spindle, it is important to determine the orientation of the shaft of the fixed hub 41 on the spindle. This allows that the interface of the harden rods 12 of the disk-stack interface tool 10 can be easily insert into the guide holes 5. In order to determine the interfaced orientation, the faces 3a will be used and guided by fixture. The determination of the interfaced orientation between the disk-stack interface tool 10 and the shaft of the fixed hub can be easily done.

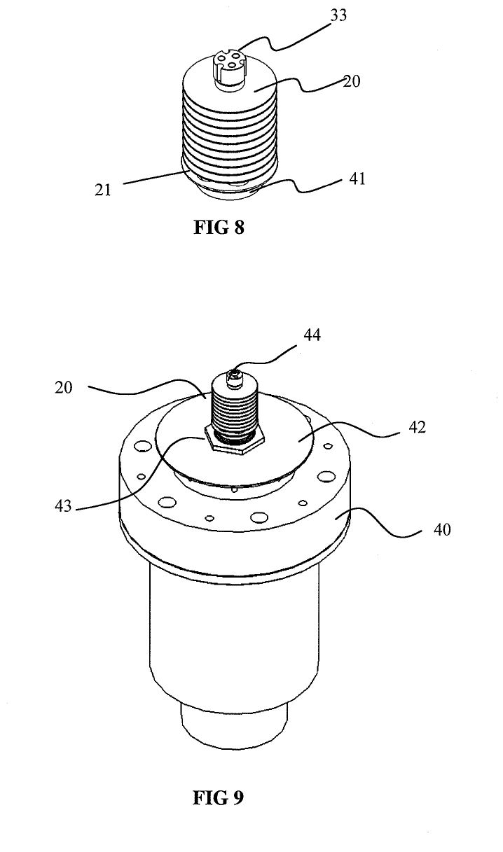

Referring to FIG. 8, there is provided a plan view of the disk-stack that has been transferred to the fixed hub in accordance with one embodiment of the present invention. All items have been described in reference to FIG. 7.

Referring to FIG. 9, there is provided a plan view of the disk-stack that has been secured to the fixed hub of a media servowriter in accordance with one embodiment of the present invention. The transferred disk-stack is secured by an end cap 44.

Now there is provided a more detailed description of transferring the disk-stack from the gripper 30 to the fixed hub 41. During insertion of the disk-stack 20 by the gripper 30, the disk-stack 20 will be pushed into the fixed hub 41. When the disk-stack 20 reaches to the bottom of the fixed hub 41, the sensor will be turned on to indicate the completion of the insertion. Then, the gripper 30 will be opened and the holder 33 will be pushed down to assist the lifting of the gripper 30. The other function of the holder 33 is to hold the disk-stack 20 so as to prevent multiple disks and spacers from being jammed to the disk-stack interface tool 10. This also helps to minimize the friction or rubbing between multiple disks 24 and spacers 25 and the rods 12. After the gripper 30 is fully lifted, the holder 33 will be retracted allowing the gripper 30 to be easily removed by robot or human hands. The completion to secure the disk-stack 20 is to clamp the disk-stack 20 by the end cap and screw 44. The final secure for the disk-stack 20 may be tightened by the torque wrench to ensure even clamping before servo writing on the servo writer begins.

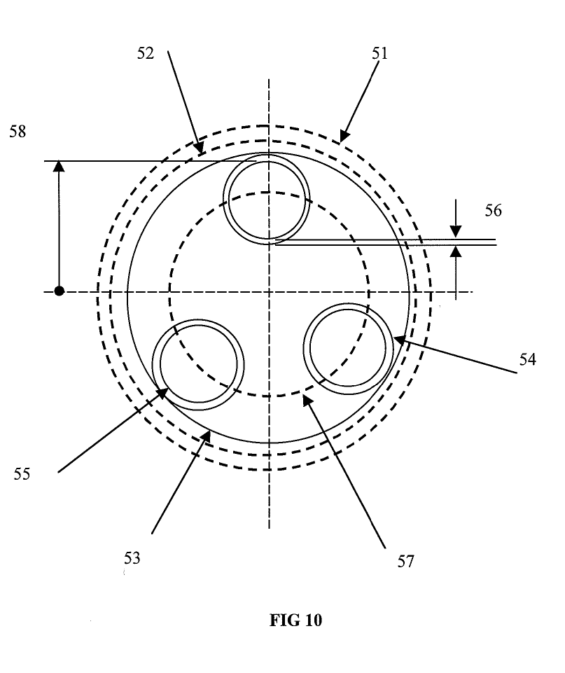

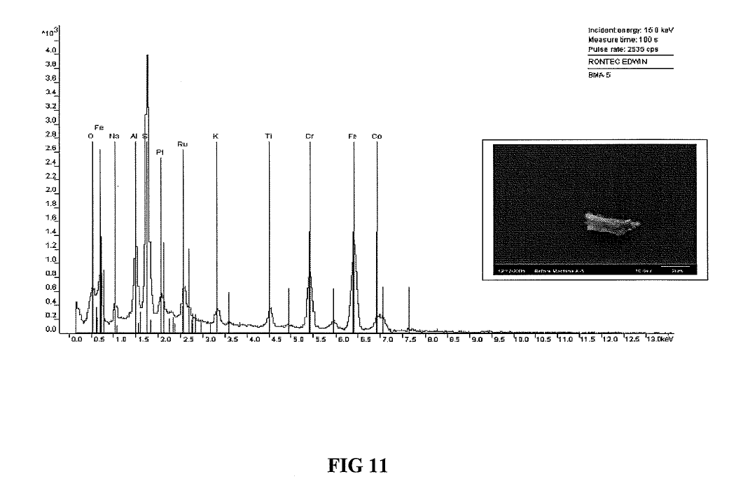

Referring to FIG. 10, there is provided a schematic diagram showing the diameter relationships among the fixed hub, disk, and disk-stack interface tool in accordance with one embodiment of the present invention. As shown in FIG. 10, the disk inner diameter may be between maximum 51 and nominal 52; the shaft of the stacker/de-stacker or fixed hub has an outer diameter 53 with the guide holes 54; the rod of the disk-stack interface tool has an outer diameter 55 where the gap between the rod and the guide hole is called the clearance 56; the disk-stack interface tool has an inner diameter 57; and the distance between the outer edge of the rod and the center line is the disk-stack interface tool's outer radius 58.

By detailed process analysis, the shaft diameter 53 during stacking or de-stacking is recommended to be 2 to 4 mils smaller than the disk ID 52 to avoid rubbing to the shaft 3. The stacking or de-stacking process would be performed with guided slide to prevent tilting of the disk stack. Before transferring the disk stack 20 by the gripper 30, the disk-stack interface tool 10 would be inserted to the disk stack 20. At this interface, it is recommended that the disk-stack interface tool's diameter 57 is smaller than the hub diameter 53 allowing good holding to the disk stack. During insertion of the disk stack to the spindle hub, the spindle hub diameter 53 is recommended to be larger than the disk-stack interface tool diameter 57 for easy insertion and preventing minimal rubbing. Due to the pin and hole clearance 56 between the rod of the disk-stack interface tool and the guide holes of the hub, placement or removing disk stack would tend to lean to one side. To avoid rubbing and particle generation due to offset in handling, the disk-stack interface tool's outer radius 58 is an important parameter to be verified in manufacturing. Jig and fixture would be made to ensure that manufacturing meets the design specification.

During the stacking/de-stacking process, contact and rubbing between shaft 3, disk 24 and spacer 25 are unavoidable, resulting in contamination. Especially, metallic particles in nano size (0.1 micron, unable to be seen by naked eye) are found during the contact. Careful design in mechanism to tightly control the tolerance would only result in expensive cost in tools and fixtures. Lose controls in machining would result in bad performance during servo writing. Tolerance controls is important to ensure good holding and low PES (Position Error Signal) performance during servo writing. Due to the tight controls in tolerance, particles can be easily generated when handling the disk and spacers. Since all the parts are not fabricated with the exact same size with nominal dimension, the disk and spacer placement with contact to the shaft would create contact and rubbing.

The contact and rubbing also result from the mechanism design. A good design would use all datum to control the xyz axis to ensure machine performance. However, all parts after being machined would have produced individual tolerances in flatness, parallelism and perpendicular characteristics. When being assembled and fine adjusted, minimal contact and rubbing would still be created. Indirectly, this would result in particles resting on the disk surfaces. All parts that are polished to obtain a stringent surface finish would result in high cost. Material hardness is important to ensure wear and tear after long hours of use.

Due to the high performance required in servo writing, scratches of parts especially spacers 25 and hub 41 are highly undesirable. The scratches would result in parallelism and flatness issue occurring during stacking on a media servowriter. Because of the interfacing between the disk-stack and head-stack, head vibration is extremely important to avoid any x-harmonic being generated that results in bad VCM holding. Low vibration is required if possible design close to VCM performance would provide good servo writing.

In order to minimize the contamination caused by the metal contact and rubbing, one way is by coating the stacker/de-stacker module, the disk-stacker interface tool, the gripper, spacers, and the hub. There are various types of coating being applied in present technologies. In order to ensure part cleanliness, common coating methods for the metal parts used in automation include electroless nickel plating and anodizing to create deposition. These types of coating are not recommended when coating precision parts that require micron tolerance controls. The size of the parts after plating would not be the same as compared to before plating process is done. The size of the part can be easily out by 0.0005″ to 0.001″. In order to control the coating dimension, another type of coating is required.

For precise control in coating dimension and also to ensure part durability, diamond like coating (DLC) is commonly used in precision part controls. It ensures minimal build up of material being deposited to the metal parts and also ensures surface hardness build on the coating. The build up of approximately 1 micron would not affect the precision quality. However, the disadvantage of DLC coating is non-conductive after coating. During servo writing, parts that could not pass through electric current would result in high resistance. This will easily damage the GMR heads.

Another type of coating that produces high quality deposition is ta-C. It is produced using FVCA technology (Filtered Cathodic Vacuum Arc) with a non-hydrogenated process. It creates harder, denser and smoother parts after coating. Importantly, this type of coating is similar to DLC coating, with a deposit of 1 micron on the part surface which is very hard and conductive. Hardness will ensure durability when parts are in contact to avoid minimal scratches. The conductivity is important in servo writing process to ensure GMR heads' performance. Ta—C coating also produces minimal nano size particles being generated from the stacking or de-stacking process.

Several experiments were conducted to verify the improvements gained from the use of ta-C coating on the fixed hub, stacker/de-stacker module, disk-stack interface tool and spacers.

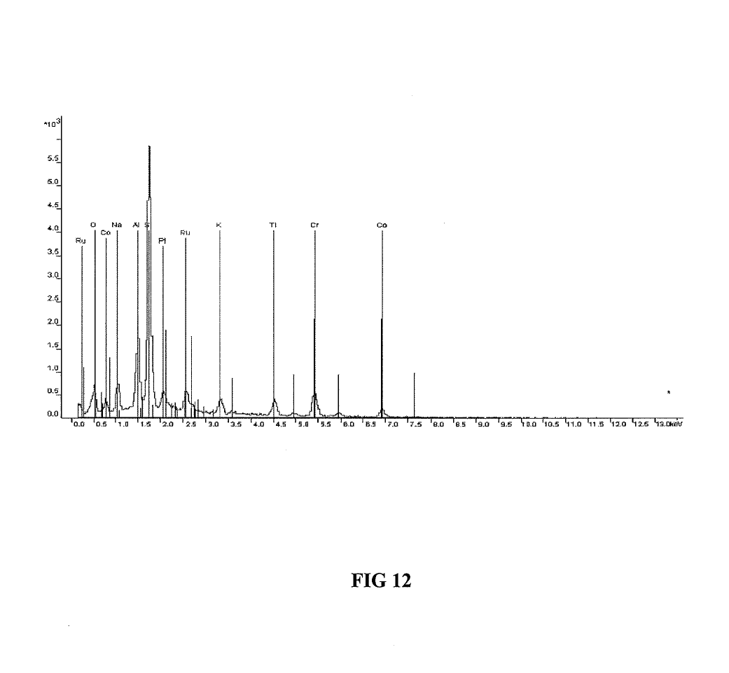

The first experiment involved the normal use of the stacker/de-stacker module, disk-stack interface tool, and spacers without any coating. SEM-EDX was used to investigate the composition of the inorganic particulates present in the discs after tacking and de-stacking operation. FIG. 11 is an exemplary graphic showing the existence of Fe and increase of Cr on a disk by SEM-EDX analysis after the disk went through the stacking/de-stacking process without coating.

The second experiment involved coating the stacker/de-stacker module, spacers and disk-stack interface tool with ta-C, and counting the increase in the number of particulates created with repeated stack and de-stack operation. Table 1 shows the drastic reduction of the stainless steel particulates after the ta-C coating was applied. This coating has a low coefficient of friction and is harder, denser and smoother than DLC films deposited by other methods. As such, it increases wear resistance. FIG. 11 is an exemplary graphic showing the absence of Fe and decrease of Cr on a disk by SEM-EDX analysis after the disk went through the stacking/de-stacking process with Ta—C coating.

TABLE 1
Comparison between ta-C coated and non ta-C coated parts

| | Stack (No. of | |
|---|---|---|
| | particles) | De-stack (No. of particles) |
| No ta-C coating on spacer, | 3 | 5 |
| Insertion tool, and transfer | | |
| hub | | |
| ta-C coating on spacer, | 0 | 0 |
| insertion tool, and transfer | | |
| hib | | |

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A system for assembling a disk-stack with multiple disks and spacers and transferring the assembled disk-stack, said system comprising:
a stacker/de-stacker module for assembling the disk-stack with multiple disks and spacers; wherein the stacker/de-stacker module comprises a module base and a shaft integrally attached to the module base, and wherein the shaft is so configured that it has a central thread, and a plurality of guide holes, thereby the multiple disks and spacers are assembled on the shaft to form the disk-stack;
a disk-stack interface tool for maintaining the assembled disk-stack during the transfer;
wherein the disk-stack interface tool comprises a tool base and a plurality of harden rods integrally attached to the tool base, where the tool base is so configured that it has a plurality of stopper holes; and
a transferring means for transferring the assembled disk-stack to a fixed hub of a media servowriter.

2. The system of claim 1, wherein the harden rods have a chamfer or round end configuration; thereby the chamfer or round end assists the tool during insertion.

3. The system of claim 1, wherein the shaft of the stacker/de-stacker module has a configuration that is complementary to the one of the rods of the disk-stack interface tool.

4. The system of claim 1, wherein the disk-stack further comprises a bottom disk spacer, wherein the bottom disk spacer is designed with chamfered feature and relief holes to make the spacer lighter and to reduce the inertia of the disk-stack during spinning.

5. The system of claim 1, wherein the shaft of the stacker/de-stacker module has a configuration of triangle shape that is complementary to determine the orientation of spindle motor position when transferring the disk-stack.

6. The system of claim 1, wherein the transferring means is a gripper, wherein the gripper comprises a right, a left jaw, and a beam, where the two jaws are coupled pivotally to each end of the beam, and wherein the beam has a holder at its central location that allows the harden rods of the disk-stack interface tool to move freely into the guide holes of the module shaft; thereby the gripper can hold the disk-stack with the right jaw and left jaw for the transfer.

7. The system of claim 6, wherein the gripper has more than two jaws.

8. The system of claim 1, wherein the harden rod is longer than the length from the top spacer to the bottom disk spacer of the disk stack.

9. The system of claim 1, wherein the guided holes is coated to allow easy sliding for the harden rods so as to prevent metal jamming and fusing caused by the friction.

10. The system of claim 1, wherein the stacker/de-stacker module, the disk-stack interface tool, the transferring means, and the spacers are coated with Ta—C.

11. A media servowriter comprising:
a fixed hub having a hub base and a hub shaft integrally coupled to the hub base, wherein the hub shaft receives a disk-stack with multiple disks and spacers;
a spindle air bearing; wherein the fixed hub is coupled to the spindle air bearing so that the spindle air bearing will rotate the fixed hub in servo-writing process; and
a locking means for locking the assembled disk-stack onto the fixed hub.

12. The media servowriter of claim 11, further comprises a fixed clock disk and lock nut; wherein the fixed hub and the spindle air bearing are spaced by the fixed clock disk and lock nut.

13. The media servowriter of claim 11, wherein the locking means is an end cap.

14. The media servowriter of claim 11, wherein the fixed hub has a configuration of triangle shape that is complementary to determine the orientation of spindle motor position when transferring the disk-stack with the gripper.

15. The media servowriter of claim 11, wherein the disk-stack is assembled off-line and transferred to the fixed hub as a block; wherein the disk-stack is assembled by a stacker/de-stacker module for assembling the disk-stack with multiple disks and spacers; wherein the stacker/de-stacker module comprises a module base and a shaft integrally attached to the module base, and wherein the shaft is so configured that it has a central thread, and a plurality of guide holes, thereby the multiple disks and spacers are assembled on the shaft to form the disk-stack.

16. The media servowriter of claim 15, where the guided holes is coated to allow easy sliding.

17. The media servowriter of claim 15, wherein the assembled disk-stack is transferred from the stacker/de-stacker module to the fixed hub by a gripper and a disk-stack interface tool; wherein the disk-stack interface tool for maintaining the assembled disk-stack during the transfer; wherein the disk-stack interface tool comprises a tool base and a plurality of harden rods integrally attached to the tool base, where the tool base is so configured that it has a plurality of stopper holes; and wherein the gripper comprises a right, a left jaw, and a beam, where the two jaws are coupled pivotally to each end of the beam, and wherein the beam has a holder at its central location that allows the harden rods of the disk-stack interface tool to move freely into the guide holes of the module shaft; thereby the gripper can hold the disk-stack with the right jaw and left jaw for the transfer.

18. The media servowriter of claim 17, wherein the disk-stack further comprises a bottom disk spacer, wherein the bottom disk spacer is designed with chamfered feature and relief holes to make the spacer lighter and to reduce the inertia of the disk-stack during spinning.

19. The media servowriter of claim 17, wherein the stacker/de-stacker module, the disk-stack interface tool, the transferring means, the spacers, and the fixed hub are coated with Ta—C.

20. A method comprising:
assembling a disk-stack with multiple disks and spacers; wherein the disks and spacers are sequentially and alternately disposed against each other on an assembling means off-line;
transferring the assembled disk-stack from the assembling means to a fixed hub of a media servowriter by a transferring means; and
locking the assembled disk-stack with a locking means.

21. The method of claim 19, wherein the assembling means is a stacker/de-stacker module, wherein the stacker/de-stacker module comprises a module base and a shaft integrally attached to the module base, and wherein the shaft is so configured that it has a central thread, and a plurality of guide holes, thereby the multiple disks and spacers are assembled on the shaft to form the disk-stack.

22. The method of claim 19, wherein the transferring means comprises a gripper and a disk-stack interface tool; wherein the disk-stack interface tool for maintaining the assembled disk-stack during the transfer; wherein the disk-stack interface tool comprises a tool base and a plurality of harden rods integrally attached to the tool base, where the tool base is so configured that it has a plurality of stopper holes; and wherein the gripper comprises a right, a left jaw, and a beam, where the two jaws are coupled pivotally to each end of the beam, and wherein the beam has a holder at its central location that allows the harden rods of the disk-stack interface tool to move freely into the guide holes of the module shaft; thereby the gripper can hold the disk-stack with the right jaw and left jaw for the transfer.
